(19) United States
(12) Patent Application Publication
(10) Pub. No.: US 2008/0262153 A1
(43) Pub. Date: Oct. 23, 2008

(54) Thermosetting Powder Paint Composition and Polyester Resin Which Can be Used for Its Manufacture

(76) Inventor: Gerhard Reich, Wels (AT)

Correspondence Address: K.F. ROSS P.C., 5683 RIVERDALE AVENUE, SUITE 203 BOX 900, BRONX, NY, 10471-0900, US

(21) Appl. No.: 11/795,699

(22) PCT Filed: Dec. 15, 2005
(86) PCT No.: PCT/AT05/00506

§ 371 Date: Jul. 7, 2008

(30) Foreign Application Priority Data
Jan. 20, 2005 (AT) A 86/2005

(51) Int. Cl. C08L 67/02; C08G 63/02

(52) U.S. Cl. 524/601; 528/272

(57) ABSTRACT

Thermosetting powder paint composition and polyester resin which can be used for its manufacture.

The invention relates to thermosetting powder paint compositions based on carboxyl group-containing polyester resins as well as polyepoxides and/or β-hydroxyalkylamides as curing agents.

The polyester resins have an acid number of 10 to 100 and a hydroxyl number of at most 15 mg KOH/g polyester resin and consist of at least 50 mol %, with respect to the totality of the dicarboxylic acids contained, of units of isophthalic acid, and of at least 50 mol %, with respect to the totality of the diols contained, of units of neopentyl glycol, and contain a maximum of 10 mol %, with respect to the totality of all dicarboxylic acids and diols, of monomers having a functionality of 3 or greater.

Through the addition of 0.05 to 5 wt. % of a heterocyclic polycarboxylic acid into the powder paint mixture, preferably through melting of this acid into the polyester resin used for the manufacture of the powder paint, highly weather-resistant powder coatings with outstanding mechanical properties and surface appearance can be achieved.

The invention relates to thermosetting powdered formulations based on carboxyl-functional polyester resins and binding agent components which are suitable for their crosslinking, as well as terminal carboxyl groups for the manufacture of powder paint compositions.

Due to their lack of solvents, powder paints are held in high regard both for economic and ecological reasons. They possess a number of convincing favorable technical properties and, when formulated properly, also have a good to high resistance to weathering.

Thermosetting powder paints, above all, and particularly those which have terminal carboxyl groups as their basis, have found the widest range of applications. They are well known according to the prior art. Some noteworthy examples include DE 2 163 962 A1, DE 2 618 729 A1, DE 4 012 020 A1, U.S. Pat. No. 4,471,108 A and EP 0 389 926 B1. These documents describe formulations which essentially contain the aromatic dicarboxylic acids terephthalic acid and isophthalic acid. The binding agent components used for crosslinking are polyepoxide compounds, preferably triglycidyl isocyanurate. EP 0 110 450 B1 discloses powder coatings based on carboxyl group-containing polyesters with acid numbers of between 10 and 30 mg KOH/g and diglycidyl phthalates, with diglycidyl esters of a phthalic acid such as phthalic, terephthalic and isophthalic acid and hydro-derivatives thereof such as hexahydrophthalic acid, 1,4-cyclohexane dicarboxylic acid being meant.

According to the teaching of EP 0 389 926 B1, the resistance to weathering that can be achieved on the basis of such formulations can be maximized if isophthalic acid functions as the solely used aromatic dicarboxylic acid in the resin formulations, which is to say that no terephthalic acid is used. According to the above-described documents, polyesters having approximately equimolar proportions of terephthalic and isophthalic acids have improved resistance to weathering in comparison to formulations of at least 70 mol. % terephthalic acid and at most 30 mol. % isophthalic acid, but the mechanical characteristics (flexibility) of such systems are insufficient for a number of applications. Moreover, EP 0 389 926 B1 discloses that the decrease in flexibility of the coatings—which is associated with the preferred or sole use of isophthalic acid—can be counteracted if 1,4-cyclohexane dicarboxylic acid is present with a molar component of at least 5% with respect to the totality of the dicarboxylic acids used in the resin formulation.

As studies of the applicant show, while the examples disclosed in EP 0 389 926 B1 produce better flexibility than coatings based on isophthalic acid-rich polyester resins that are formulated without 1,4-cyclohexane dicarboxylic acid, the thus achieved flexibility does not measure up to that of coatings which contain terephthalic acid as the predominantly used dicarboxylic acid. The obligatory use of raw resinous materials of functionality 3 or greater in the formulation of those polyesters brings about losses in the surface appearance such as, for example, worsened flow, [and] glass reduction through “pinholes” of the baked formulations manufactured therewith.

EP 0 487 485 A2 and EP 0 561 102 B1 describe polyesters for the manufacture of which 1,4-cyclohexane dicarboxylic acid is used exclusively or at least predominantly as the dicarboxylic acid. Polyesters of the type described can then be formulated, according to these documents, together with a polyepoxide compound, preferably triglycidyl isocyanurate, into powdery thermosetting coating masses which exhibit improved resistance under rapid weathering.

However, is has been observed that—in contrast to the rapid weathering in the lab—such powder coatings based on cycloaliphatic polyesters take on damage extraordinarily quickly under natural weathering. What is more, in comparison to the aromatic dicarboxylic acids generally used, terephthalic acid and isophthalic acid, 1,4-cyclohexane dicarboxylic acid is quite significantly more expensive. It is therefore not a surprise that these systems have virtually no practical significance.

EP 0 322 834 B1 teaches that β-hydroxyalkylamides can be used instead of the toxicologically dubious curing agent triglycidyl isocyanurate for the production of outdoor-durable powder paints based on carboxyl-functional polyester resins. Moreover, this EP B1 discloses that the additional use of crystalline, carboxyl group-containing material such as aliphatic C4-C22 polycarboxylic acids and/or polymeric polyanhydrides during the production of powder paints leads to improved flexibility and improved flowing which, in turn, leads to improved smoothness and increased gloss in the resulting coatings.

The examples disclosed in EP 0 322 834 B1 do not relate to polyester based on isophthalic acid, and in the experiments carried out by the applicant it can be seen that the additional use of dodecanoic acid especially preferred in EP 0 322 834 B1 does not lead to the desired objective in such polyester resins.

EP 0 649 890 B1 describes, analogously to EP 0 389 926 B1, how highly weather-resistant powder coatings with improved flexibility can be manufactured on the basis of carboxyl group-containing polyester resins with a molar component of isophthalic acid of >80% (with respect to the totality of the dicarboxylic acids used) and β-hydroxyalkylamides as curing agents.

As with EP 0 389 926 B1, the mechanical characteristics of the disclosed formulations are insufficient.

A further strategy for increasing the flexibility of powder paints is to use semicrystalline polyesters in addition to the amorphous polyester resins generally used. The background for the use of partially crystalline resins lies in the fact that they, under the condition of a sufficiently high crystalline melting point, are solids even when their glass transition temperature lies far below room temperature. Their disposition as a solid makes them suitable as a raw material for powder paints—which of course must be solid at room temperature—but their low glass transition temperature increases the flexibility of the coating beyond the point which usually characterizes (amorphous) powder paint binding agents with their usual glass transition temperature of >50° C. EP 0 322 834 B1 mentioned in the foregoing belongs to the documents in which this prior art is described, other examples being WO91/14745A1, DE 197 54 327 A1 or WO97/20895A2.

It is noteworthy that the freedom of formulation is quite small in the conception of crystalline resins. The achievement of a suitable melting point is given a high priority, while important binding agent characteristics must take a back seat at times as a result. The narrow base of suitable raw materials brings about prices that are higher many times over and that are increased further by expensive technical demands of the method (defined crystallization through defined temperature control after the synthesis of the resins and expensive pulverization of the extremely tough and hard masses). However, it is especially problematic that the partially crystalline binding agent components in the powder paint—in combination with the amorphous (main) component—no longer crystallizes as spontaneously and willingly as in its pure form, which has a decidedly negative effect on the grindability of the powder paint masses over the course of the manufacturing process as well as on the storage stability of the powder paints, since the—originally—semicrystalline resin component is present in more or less amorphous form in the finished powder paint and not only makes the future coating more flexible by virtue of its low glass transition temperature, but leads to the abovementioned difficulties as well. Moreover, due to the very different physical characteristics of amorphous and semicrystalline polyester, the processing of the extrusion process can only be characterized as very demanding. The wealth of difficulties associated with this strategy are easy to see in the detailed explanations in WO91/14745 A1 (page 15, line 11 to page 18, line 27). The measures disclosed there can hardly be characterized as economically reasonable routine methods for the manufacture of powder paints.

There is hence a need for powder paint compositions based on carboxyl group-containing polyester resins and crosslinking agents for the thermosetting of these resins which allow for the manufacture of highly weather-resistant and, at the same time, flexible powder coatings with first-class surface appearance, which prove to be trouble-free with respect to their grindability and storage stability, and which are comparable in price to formulations based on amorphous polyester resins under the predominant use of isophthalic acid and, optionally, terephthalic is acid. Moreover, there is a need for a method for the manufacture of such powder paint compositions.

It has been found, in a completely unexpected manner, that such powder paints can be achieved if carboxyl group-containing polyester resins, that consist of at least 50 mol. % with respect to the totality of all dicarboxylic acids used, of units of isophthalic acid, a polycarboxylic acid, preferably trifunctional carboxylic acid, that contains heteroatoms, is added in small quantities in a melted state, and these resins are formulated into powder paints using β-hydroxyalkylamides (such as, for example, Primid® XL 552 or Primid® QM 1260, EMS PRIMID Company) or polyepoxides (such as, for example, triglycidyl isocyanurate=Araldite® PT 810 or mixtures of terephthalic acid diglycidyl esters and trimellitic acid triglycidyl esters=Araldite® PT 910 or Araldite® PT 912, HUNTSMAN Company) as curing agents. The carboxyl group-containing polyester resins in terms of the present invention have a glass transition temperature Tg of at least 35° C., an acid number of 15 to 80 mg KOH/g and a hydroxyl number of a maximum of 15 mg KOH/g, preferably a maximum of 10 mg KOH/g.

Powder paints with a particularly advantageous combination of characteristics can be achieved through the inventive addition of 1,3,5-tris(2-carboxyethyl)isocyanurate to the resin melt.

If terephthalic acid is also used in addition to isophthalic acid for the manufacture of the inventive polyester resins, the weather resistance of the powder paints produced therewith decreases, in concordance with EP 0 389 926 B1, in comparison to the above-described coatings. In contrast to the description in EP 0 389 926 B1, however, the inventive coatings have a high level of flexibility.

The best weather resistance of the inventive coatings can be achieved if the carboxyl group-containing polyester resins used for them contain isophthalic acid as the sole aromatic dicarboxylic acid and are composed on the glycol side at least predominantly or exclusively of units of neopentyl glycol. In contrast to the known prior art, the thus produced coatings are flexible and have the best grindability, storage stability and outstanding surface appearance.

Outstanding characteristics are exhibited, for example, by formulations of a polyester resin based on isophthalic acid and neopentyl glycol with an acid number of 31 and the subsequent addition of 1.2-1.5 wt. % 1,3,5-tris(2-carboxyethyl)isocyanurate, cured with Primid XL 552 or triglycidyl isocyanurate.

1,3,5-tris(2-carboxyethyl)isocyanurate is offered by Cytec Industries Inc. under the name Powderlink® 1196 resin, for which an “average molecular weight” is indicated which corresponds exactly to the molecular weight of 1,3,5-tris(2-carboxyethyl)iso-cyanurate, which rules out a polymeric character of this commercial product.

In the product data sheet (revision date: March 2004), Powderlink® 1196 is characterized, due to its carboxylic acid functionality, as being reactive with respect to resins with free epoxide groups, as acrylic copolymers based on glycidyl methacrylate (GMA). (A combination with low-molecular, higher epoxy-functional compounds such as triglycidyl isocyanurate would be possible in theory, but would make little sense for conventional paint applications, since extremely brittle masses with no practical suitability would result from the extremely high level of crosslinking density of such formulations.) In an overview of this data sheet, the powder paint characteristics are depicted which result when, in a series of formulations based on a GMA acrylic copolymer resin and dodecanoic acid as curing agents, the latter is gradually replaced by Powderlink® 1196 resin. Here, it is striking that, as the component of Powderlink® 1196 increases in the formulations at the expense of the dodecanoic acid, the hardness of the coatings increases, but their flexibility decreases.

On the basis of this finding, it could therefore hardly be expected that the use of Powderlink® 1196 analogously to the teaching of EP 0 322 834 B1—in place of the aliphatic dicarboxylic acid dodecanoic acid—allows, in contrast to the latter, for the manufacture of thermosetting, highly weather-resistant and, at the same time, flexible powder coatings based on polyester resins having a high isophthalic acid content and a β-hydroxyalkylamide curing agent (Primid XL 522) which have a first-class surface appearance, trouble-free grindability and storage stability, and whose price is commensurate with that of conventional isophthalic acid formulations. Moreover, there is reference neither in the data sheet mentioned nor in EP 0 322 834 B1 that these good paint characteristics can be expected if such an addition is made into the melt phase of a finished or re-melted polyester resin. If, by contrast, Powderlink® 1196 is added to the raw powder paint mixture in the manner which is presented in the cited data sheet and is disclosed in an analogous manner in EP 0 322 834 B1 for the addition of dodecanoic acid, results are produced that are hardly satisfactory.

It is also surprising that these effects can be observed even though Powderlink® 1196 cannot function in the inventive formulations as a crosslinking agent for the resin component (the polyester), which of course has no epoxide groups, as indicated in the manufacturer's specifications, but rather acts as a crosslinking agent for those components such as Primid XL 552 or triglycidyl isocyanurate which are themselves generally considered to be crosslinking agents by virtue of their low molar mass and well defined structure. Rather, a crosslinking density resulting from these conditions and increased further in the environment of these curing agent molecules would be expected to exhibit increased hardness more than increased flexibility.

It can also be advantageous to manufacture so-called master batches from resin melt and heterocyclic polycarboxylic acids, preferably tricarboxylic acid, which allow for a more flexible structuring of the subsequent quantitative dosing of the polycarboxylic acid or tricarboxylic acid.

The respective polyester resins are to be combined with the above-described curing agents in accordance with the recommendations of the manufacturer of those curing agents. Besides binding agent components, powder paints generally contain other substances such as additives which are used, for example, as flowout agents, curing catalysts, degassing adjuvants, matting agents or structure-formers, as well as optional pigments and fillers. These components are mixed thoroughly and then usually homogenized in the melt with the aid of an extruder. The extrudate is cooled and subsequently ground and sieved, a process during which an upper grain size of <90 μm should be strived for.

Besides this method, the homogenization of the components in dissolved form is also known. When using a solvent, the respective powder paint can be manufactured with a subsequent spray-drying process in the classical sense. If, for example, supercritical carbon dioxide is used as a solvent, it is sufficient to release the solution obtained at normal pressure via a nozzle in order to achieve the desired powdery masses.

The thus obtained powdery masses are usually applied to the objects to be coated with the aid of a spraying apparatus under an electrostatic or tribostatic charge and baked at temperatures of between about 150 and 200° C. for approx. 5 to 30 minutes. Convection ovens or infrared radiators can be used for this purpose. The pre-heating of the parts to be coated and the application of the powder paints using the fluidized bed method is also known.

Further specifications on the manufacture and processing of powder paints can be found in the thorough monograph “Powder Coatings—Chemistry and Technology” by Pieter Gillis de Lange (Vincentz, 2004).

The inventive polyester resins are composed of at least 50 mol. %, with respect to the totality of all carboxylic acid units is used, of units of isophthalic acid, and at least 50 mol. %, with respect to the totality of all hydroxy-functional units used of units, of neopentyl glycol. As was already pointed out earlier, powder coatings manufactured using such polyester resins have an especially high level of weather stability as a consequence.

In addition, further carboxylic acids and hydroxy-functional units can be used as starting materials.

Usable as such carboxylic acids are aromatic polycarboxylic acids such as, for example, phthalic acid, terephthalic acid, trimellitic acid, pyromellitic acid, trimesinic acid, 3,6-dichlorophthalic acid and tetrabromophthalic acid. In addition, aliphatic and/or cycloaliphatic polycarboxylic acids can also be used, for example tetrahydrophthalic acid, hexahydrophthalic acid, hexahydroendomethylene tetrahydrophthalic acid, cyclohexane-1,3-dicarboxylic acid, cyclohexane-1,4-dicarboxylic acid, adipic acid, azelainic acid, succinic acid, glutaric acid, suberic acid, sebacic acid, dodecanoic acid, 1,3,5-tris(2-carboxyethyl)isocyanurate, maleic acid, fumaric acid, [and] dimeric as well as trimeric fatty acids. In place of the free carboxylic acids, functional derivatives thereof such as esters, anhydrides or acylhalogenides can also be used, provided they are available. Hydroxycarboxylic acids as well as possibly available lactones such as, for example, 12-hydroxystearic acid, ε-caprolactone, hydroxypivalinic acid or dimethylol propionic acid can also be used as sources of polyfunctional, carboxyl group-containing components. In addition to these polyfunctional carboxyl group-containing starting materials, —smaller—components of monocarboxylic acids such as, for example, benzoic acid, tert butylbenzoic acid, hexahydrobenzoic acid and aliphatic monocarboxylic acids can be used as well.

Usable as further hydroxy-functional units are, in particular, aliphatic or cycloaliphatic diols such as, for example, ethylene glycol, propane-1,2-diol, propane-1,3-diol, 2-methylpropane-1,3-diol, 2-ethyl-2-butyl-propane-1,3-diol, hydroxypivalinic acid neopentylglycol ester, butane-1,2-diol, butane-1,3-diol, butane-1,4-diol, butane-2,3-diol, pentane-1,5-diol, 3-methylpentane-1,5-diol, 2-ethyl-hexane-1,3-diol, hexane-2,5-diol, hexane-1,2-diol, hexane-1,6-diol, as well as 1,2- and α,ω-diols, cyclohexane dimethalol, cyclohexane-1,2-diol, cyclohexane-1,3-diol, cyclohexane-1,4-diol, hydrated bisphenol A, 2,2,4,4-tetramethylcyclobutane-1,3-diol, 4,8-bis(hydroxy-methyl)tricyclo[5.2.1.0^{2,6}]decane, diethylene glycol or triethylene glycol, which are derived from the higher alkanes. In addition, epoxy-functional compounds can also be used which are to be regarded as reactive inner ethers of vicinal diols. Examples of optional higher-functional polyols are glycerin, hexane-1,2,6-triol, trimethylolethane, trimethylolpropane, di-trimethylolpropane, tris-(2-hydroxyethyl)isocyanurate, pentaerythrite, sorbite or di-pentaerythrite. The hydroxycarboxylic acids serving as possible sources for hydroxy-functionality were already named among the carboxylic acids.

The manufacture of the polyester resins is performed according to methods that are known in and of themselves, through esterification or re-esterification, preferably using suitable catalysts such as dibutyl tin oxide or tetrabutyl titanate. Through the appropriate selection of the raw materials to be used and their proportion as well as the synthesis conditions, resins are obtained which possess the desired characteristic numbers—a glass transition temperature Tg of at least 35° C., an acid number of 15 to 80 mg KOH/g and a hydroxyl number of a maximum of 15 mg KOH/g, preferably a maximum of 10 mg KOH/g.

As EP 0 649 890 B1 teaches, carboxyl group-containing polyester resins can be manufactured according to two methods: In the 2-stage method applicable in any case, the less-reactive carboxylic acids are converted in a first reaction stage into hydroxy-functional polyester resins which are converted in a subsequent second reaction stage with the more-reactive carboxylic acids into the desired carboxy-functional polyester resin. By contrast, if the resin composition comprises only carboxylic acids of similar reactivity, all raw materials can be introduced at once into the reaction vessel and converted into the finished resin.

The manufacture and the characteristics of both the inventive polyester resins and those used for comparison, as well as the powder paints produced from them, are described in the following in the manner of examples, with these examples being merely intended to make the implementation of the invention clear and not to limit it. The resins were manufactured using a 2-stage method; however, based on the raw materials used, it would be just as possible to produce them using a single-stage method.

Manufacture of the Carboxy-Functional Polyester Resins:

### COMPARISON EXAMPLE A

In a 2-1 reaction vessel equipped with stirrer, temperature sensor, partial reflux column, distillation bridge and inert gas line (nitrogen), 558.30 g (5.36 mols) 2,2-dimethylpropanediol-1,3 are presented and melted under heating to a maximum of 140° C. under a nitrogen atmosphere. Under stirring, 747.63 g (4.50 mols) isophthalic acid and 0.1% (with respect to the total quantity of the finished resin) Sn-containing catalyst are then added and the mass temperature is increased incrementally to 240° C. The reaction is continued at this temperature until no more distillate occurs and the acid number (AN) of the hydroxy-functional polyester resin is <10 mg KOH/g polyester resin.

Subsequently, 193.55 g isophthalic acid (1.165 mols) are added and the esterification is continued until the desired acid number (about 31) has been reached, with the reaction being supported through an applied vacuum, approximately 100 mbars. The finished resin has the following characteristic numbers: acid number (AN) 31.2, hydroxyl number (OHN) 3.4, glass transition temperature (Tg) approx. 63° C.

### COMPARISON EXAMPLE B

### Corresponds to Example 13 from EP 0 649 890 B1

Analogously to Comparison Example A, 509.34 g (4.89 mols) 2,2-dimethylpropanediol-1,3, 20.39 5 g (0.173 mols) hexanediol-1,6, 15.43 g (0.115 mols) trimethylol propane, 0.1% (with respect to the total quantity of the finished resin), Sn-containing catalyst and 643.79 g (3.875 mols) isophthalic acid as well as 21.77 g (1.133 mols) trimellitic acid anhydride are converted in the first reaction stage to a hydroxyl-functional polyester resin.

This is converted in the manner described in the foregoing under the addition of 235.09 g (1.415 mols) isophthalic acid and 41.65 g (0.285 mols) adipic acid into the finished polyester resin. The finished resin has the following characteristic numbers: AN 46.4, OHN 3.2, Tg approx. 53.0° C.

### COMPARISON EXAMPLE C

### Corresponds to Example IV from EP 0 389 926 B1

Analogously to Comparison Example A, 480.70 g. (4.615 mols) 2,2-dimethylpropanediol-1,3, 53.68 g (0.400 mols) trimethylol propane, 0.1% (with respect to the total quantity of the finished resin), Sn-containing catalyst and 662.07 g (3.985 mols) isophthalic acid as well as and [sic] 99.88 g (0.580 mols) cyclohexane dicarboxylic acid-1,4 are converted in the first reaction stage to a hydroxyl-functional polyester resin.

This is converted in the manner described in the foregoing under the addition of 198.54 g (1.195 mols) isophthalic acid into the finished polyester resin. The finished resin has the following characteristic numbers: AN 51.5, OHN 4.5, Tg approx. 59.0° C.

### EXAMPLE 1

### Inventive

In a reaction vessel at a mass temperature of approx. 240° C., 40.36 g (0.117 mols) 1,3,5-tris(2-carboxyethyl)isocyanurate are added to a resin according to Comparison Example A and stirring continued until the mass appears homogeneous again. The resin now contains 3.0 wt. % 1,3,5-tris(2-carboxyethyl)isocyanurate and has the following characteristic numbers: AN 43.3, OHN 3.7, Tg approx. 61.0° C.

### EXAMPLE 1

### Variation, Inventive

In an apparatus according to Comparison Example A, 750 g granulated resin from Comparison Example A are presented and melted under nitrogen atmosphere through heating with the aid of a heating bath. The temperature of the mass is increased to 230° C. and 23.20 g 1,3,5-tris(2-carboxyethyl)isocyanurate are added under stirring, which results in the same concentration of this substance in the resin as in Example 1. The stirring of the mass is continued until the mass appears homogeneous. The characteristic numbers of the resin are: AN 42.8, OHN 3.5, Tg approx. 62.0° C.

### EXAMPLE 2

### Inventive

Analogously to Comparison Example A, 556.21 g (5.34 mols) 2,2-dimethylpropanediol-1,3, 0.1% (with respect to the total quantity of the finished resin), Sn-containing catalyst, 471.84 g (2.84 mols) terephthalic acid and 275.79 g (1.66 mols) isophthalic acid are converted in the first reaction stage to a hydroxyl-functional polyester resin.

This is converted in the manner described in the foregoing under the addition of 196.05 g (1.18 mols) isophthalic acid into the finished polyester resin. The finished resin has the following characteristic numbers: AN 35.4, OHN 3.6, Tg approx. 63.0° C.

Subsequently, 19.89 g (0.0577 mols) 1,3,5-tris(2-carboxyethyl)isocyanurate are added to this resin-in a reaction vessel at a mass temperature of approx. 240° C. and the stirring is continued until the mass appears homogeneous again. The resin now contains 1.5 wt. % 1,3,5-tris(2-carboxyethyl)isocyanurate and now has the following characteristic numbers: AN 42.5, OHN 3.1, Tg approx. 61.5° C.

The resins prepared according to the above-described specifications are subsequently poured off into flat sheet-metal basins and broken after cooling into granulate, grain size approx. 4 mm. They are formulated into powder paints together with further substances as set forth in the following table:

| | Test formulation no. | | | | | | | | | |
|---|---|---|---|---|---|---|---|---|---|---|
| | 1 | 2 | 3 | 4 | 5 | 6 | 7 | 8 | 9 | 10 |
| Raw material | Parts by weight | | | | | | | | | |
| Polyester resin A | 262 | — | 257 | — | 257 | 257 | 156 | 156 | 127 | — |
| Polyester resin B | — | 257 | — | — | — | — | — | — | — | — |
| Polyester resin C | — | — | — | 247 | — | — | — | — | — | — |
| Polyester resin 1 | — | — | — | — | — | — | 104 | | 127 | — |
| Polyester resin 1, var. | — | — | — | — | — | — | — | 104 | — | — |
| Polyester resin 2 | — | — | — | — | — | — | — | — | — | 257 |
| Powderlink 1196 | — | — | — | — | 3.12 | — | — | — | — | — |
| Dodecanoic acid | — | — | — | — | — | 3.12 | — | — | — | — |
| Primid ® XM-552 ¹⁾ | 12.8 | 18.0 | — | — | 14.7 | 14.7 | 14.7 | 14.7 | — | 17.8 |
| TGIC ²⁾ | — | — | 18.0 | 28.0 | — | — | — | — | 20.8 | — |
| Byk 364 ³⁾ | 5.0 | 5.0 | 5.0 | 5.0 | 5.0 | 5.0 | 5.0 | 5.0 | 5.0 | 5.0 |
| Benzoin | 0.7 | 0.7 | 0.7 | 0.7 | 0.7 | 0.7 | 0.7 | 0.7 | 0.7 | 0.7 |
| Licowax Micropulver C ⁴⁾ | 1.7 | 1.7 | 1.7 | 1.7 | 1.7 | 1.7 | 1.7 | 1.7 | 1.7 | 1.7 |
| Worlée Add 902 ⁵⁾ | 1.7 | 1.7 | — | — | 1.7 | 1.7 | 1.7 | 1.7 | — | 1.7 |
| Martinal OL 104 ⁶⁾ | 9.9 | 9.9 | 9.9 | 9.9 | 9.9 | 9.9 | 9.9 | 9.9 | 9.9 | 9.9 |
| Reafree C 4705-10 ⁷⁾ | — | — | 1.7 | 1.7 | — | — | — | — | 1.7 | — |
| Portaryte B 10 ⁸⁾ | 23.9 | 23.9 | 23.9 | 23.9 | 23.9 | 23.9 | 23.9 | 23.9 | 23.9 | 23.9 |
| Bayferrox 3920 ⁹⁾ | 8.70 | 8.70 | 8.70 | 8.70 | 8.70 | 8.70 | 8.70 | 8.70 | 8.70 | 8.70 |
| Bayferrox 110M ¹⁰⁾ | 3.05 | 3.05 | 3.05 | 3.05 | 3.05 | 3.05 | 3.05 | 3.05 | 3.05 | 3.05 |
| Carbon black FW 2V ¹¹⁾ | 0.56 | 0.56 | 0.56 | 0.56 | 0.56 | 0.56 | 0.56 | 0.56 | 0.56 | 0.56 |

| | |
|---|---|
| 1) | EMS Primid |
| 2) | Huntsman |
| 3) | BYK Chemie |
| 4) | Clariant |
| 5) | Worlée |
| 6) | Al-Group |
| 7) | Cray Valley |
| 8) | Ankerpoort |
| 9) | Bayer |
| 10) | Bayer |
| 11) | Degussa |

Manufacture of the Powder Paints:

The raw materials of the individual formulations were mixed thoroughly in a mixer of the Pilot 3 type of the Thermo Prism Company and subsequently extruded using an extruder of the Prism Twinscrew 16 mm type, screw length=24-fold screw diameter (tempering of the hot zones in the direction of the material flow: 100, 130 and 125° C., rotary speed 400 min⁻¹). The cooled extrudates were broken, ground on a classifier mill and sieved off with an upper grain limit of 85 μm. The powder paints were then applied with a layer thickness of approx. 80 μm (finished paint film) onto chromated aluminum sheets having a thickness of 0.7 mm. All formulations proved to have a good grindability.

Baking Conditions:

Gradient oven: (BYK-Gardner Co.; to evaluate the mechanical values):

15 min. 150-220° C.

Circulating-air oven (Heraeus Co.; to evaluate the maintenance of gloss after rapid weathering):

15 min. 200° C.

The remaining powder paints not applied were stored for three weeks at 35° C. and did not exhibit any worsening of their flow behavior.

In intervals which correspond to 10° C. temperature intervals, the test sheets baked in the gradient oven were subjected to a ball-impact test per ASTM D 2794 (“Standard Test method for Resistance of Organic Coatings to the Effects of Rapid Deformation [Impact]”); load 20 in-lb, ball diameter 15.9 mm.

The test sheets baked in the circulating-air oven were subjected to a load in the Q-Panel Accelerated weathering Tester QUV/SE of The Q-Panel Company for 600 h. (UVB 313 lamps, 4 hours of dew at 40° C., 4 hours of radiation at 50° C., radiation strength 0.67 W/M). After the load, the gloss per ISO 2813 of the test sheets measured at the beginning was measured again and the residual gloss was determined.

The results are shown in the following in the form of a table:

| Test formulation | 1 | 2 | 3 | 4 | 5 | 6 | 7 | 8 | 9 | 10 |
|---|---|---|---|---|---|---|---|---|---|---|
| Ball impact | Pronounced | Pronounced | Pronounced | Cracks | Cracks | Pronounced | 165 | 165 | 180 | 160 |
| | cracks | cracks | cracks | | | cracks | | | | |
| Surface appearance | 2 | 1 | 4 | 3 | 3 | 1 | 1 | 1 | 1 | 1 |
| Flow | 5 | 1-2 | 1 | 5 | 3 | 1 | 1-2 | 1-2 | 1 | 1 |
| Residual gloss | 78.7 | 79.8 | 69.2 | 71.8 | 78.6 | 79.8 | 78.7 | 77.5 | 69.2 | 48.6 |

Surface appearance, flow: “1” stands for “very good,” “5” for “very bad.”

Surface appearance, flow: “1” stands for “very good,” “5” for “very bad.”

It is striking that all of the formulations from Comparison Examples (1-6) exhibit more or less pronounced cracks over the entire baking range according to the ball-impact test described in the foregoing. Only the inventive formulations (7-10) exhibit a crack-free result starting at a certain temperature level (the numbers in the respective line of the table designate this temperature in ° C.).

The residual gloss values show, with the exception of test formulation 10 which, besides isophthalic acid, also contains considerable amounts of terephthalic acid in the polyester, a level which is approximately comparable. Formulations 1 (comparison example) as well as 7 and 8 (inventive examples) differ with otherwise comparable formulation through the non-use and use, respectively, of the heterocyclic tricarboxylic acid 1,3,5-tris(2-carboxyethyl)isocyanurate, and it is striking that the values found for residual gloss are very similar. The same applies to formulations 3 (comparison example) and 9 (inventive example), albeit at a somewhat lower level of residual gloss. It can therefore be concluded that the inventive additional use of 1,3,5-tris(2-carboxyethyl)isocyanurate (Powderlink® 1196) has no influence on the residual gloss value of the test formulations.

With respect to surface appearance and flow, all of the inventive formulations are very good to good. This is predominantly not the case with the comparison formulations.

### CONCLUSION

The inventive method and the inventive formulations allow for the manufacture of highly weather-resistant and, at the same time, flexible powder coatings with first-class surface appearance and flow which prove to be trouble-free with regard to their grindability and storage stability, and which are comparable in terms of price with formulations based on amorphous polyester resins while predominantly using isophthalic acid and, optionally, terephthalic acid.

1. A thermosetting powder paint composition which comprises a) at least one carboxyl-functional polyester resin having an acid number of 10-100 mg KOH/g polyester resin and a hydroxyl number of at most 15 mg KOH/g and substantially based on units of dicarboxylic acids, diols and monomers having a functionality of 3 or greater, wherein, as dicarboxylic acids, at least 65 mol %, with respect to the totality of all dicarboxylic acids used, of aromatic dicarboxylic acids with 8 to 16 C atoms, among which aromatic dicarboxylic acids the component of isophthalic acid is 50 mol %, with respect to the totality of all dicarboxylic acids contained, and a maximum of 35 mol %, with respect to the totality of all dicarboxylic acids contained, of aliphatic dicarboxylic acids with 4 to 22 C atoms and/or cycloaliphatic dicarboxylic acids with 8 to 16 C atoms are contained, and, as diols, at least 50 mol %, with respect to the totality of all diols contained, of branched aliphatic diols with 4 to 12 C atoms, which branched aliphatic diols can also contain an ester group and among which is at least 50 mol % neopentyl glycol, with respect to the totality of all diols contained, and a maximum of 50 mol %, with respect to the totality of all diols contained, of linear aliphatic diols with 2 to 22 C atoms and/or cycloaliphatic diols with 6 to 16 C atoms are contained, and wherein the monomers having a functionality of 3 or greater are contained in a quantity of a maximum of 10 mol % with respect to the totality of all dicarboxylic acids and diols, b) at least one substance which is made capable of forming covalent bonds with the polyester resin by the action of heat and which has at least one polyepoxide compound having a functionality of 2 or greater and/or at least one β-hydroxyalkylamide having a functionality of 2 or greater, and c) conventional additives wherein the powder paint composition contains 0.05 to 5 wt. %, with respect to the totality of the powder paint composition, of a heterocyclic polycarboxylic acid.

2. The powder paint composition as set forth in claim 1 wherein the heterocyclic polycarboxylic acid is a tricarboxylic acid.

3. The powder paint composition as set forth in claim 2 wherein the tricarboxylic acid is 1,3,5-tris(2-carboxyethyl)isocyanurate.

4. The powder paint composition as set forth in claim 1 wherein the heterocyclic polycarboxylic acid, preferably tricarboxylic acid, is contained in the polyester resin distributed by melting.

5. The polyester resin with terminal carboxyl groups for the manufacture of thermosetting powder paint compositions as set forth in claim 1, which has an acid number of 10-100 mg KOH/g polyester resin and a hydroxyl number of at most 15 mg KOH/g polyester resin and is substantially based on units of dicarboxylic acids, diols and monomers having a functionality of 3 or greater, wherein, as dicarboxylic acids, at least 65 mol %, with respect to the totality of all dicarboxylic acids used, of aromatic dicarboxylic acids with to 16 C atoms, among which aromatic dicarboxylic acids the component of isophthalic acid is 50 mol %, with respect to the totality of all dicarboxylic acids contained, and a maximum of 35 mol %, with respect to the totality of all dicarboxylic acids contained, of aliphatic dicarboxylic acids with 4 to 22 C atoms and/or cycloaliphatic dicarboxylic acids with 8 to 16 C atoms are contained, and, as diols, at least 50 mol %, with respect to the totality of all diols contained, of branched aliphatic diols with 4 to 12 C atoms, which branched aliphatic diols can also contain an ester group and among which is at least 50 mol % neopentyl glycol, with respect to the totality of all diols contained, and a maximum of 50 mol %, with respect to the totality of all diols contained, of linear aliphatic diols with 2 to 22 C atoms and/or cycloaliphatic diols with 6 to 16 C atoms are contained, and wherein the monomers having a functionality of 3 or greater are contained in a quantity of a maximum of 10 mol %, with respect to the totality of all dicarboxylic acids and diols wherein the polyester resin contains 0.05 to 5 wt. % of a heterocyclic polycarboxylic acid.

6. The polyester resin as set forth in claim 5 wherein the heterocyclic polycarboxylic acid is a tricarboxylic acid.

7. The polyester resin as set forth in claim 6 wherein the tricarboxylic acid is 1,3,5-tris(2-carboxyethyl)isocyanurate.

8. The polyester resin as set forth in claim 5 wherein the heterocyclic polycarboxylic acid, preferably tricarboxylic acid, is contained in the polyester resin distributed by melting.
